(19) United States
(12) Patent Application Publication
(10) Pub. No.: US 2016/0103750 A1
(43) Pub. Date: Apr. 14, 2016

(54) APPLICATION PROGRAMMING INTERFACE MONITORING TOOL NOTIFICATION AND ESCALATION METHOD AND SYSTEM

(71) Applicant: ADP, LLC, Roseland, NJ (US)

(72) Inventors: Thomas A. COOPER, Sutton, MA (US); Ijoni META, Roseland, NJ (US)

(21) Appl. No.: 14/512,100

(22) Filed: Oct. 10, 2014

(51) Int. Cl. G06F 11/34; G06F 9/54

(52) U.S. Cl. CPC G06F 11/3495; G06F 11/3409; G06F 9/541

(57) ABSTRACT

Methods and systems for reporting performance data for application programming interfaces (APIs) are provided. A method includes receiving a subscription request from a subscriber for a particular API of a plurality of APIs, and monitoring performance of the particular API for a predetermined event that includes a change in at least one of performance status for the particular API and one or more various measurements of performance of the particular API. The method further includes comparing the predetermined event to a table or database of information that includes notification and alert rules for the particular API that specify notification policies for various predetermined events, and when the predetermined event matches at least one of the notification and alert rules, sending, by the computer system, a notification or alert to the subscriber based on the notification policy for the at least one of the notification and alert rules.

### TECHNICAL FIELD

The invention relates to software performance and, more particularly, to methods and systems for reporting on the operating status and performance alerts associated with released application programming interfaces.

### BACKGROUND

An application programming interface (API) specifies how various software components should interact with each other. In addition to accessing databases or computer hardware, such as hard disk drives or video cards, an API can be used to ease the work of programming graphical user interface components, to allow integration of new features into existing applications (a so-called “plug-in API”), or to share data between otherwise distinct applications. In practice, many times an API comes in the form of a library that includes specifications for routines, data structures, object classes, and variables. In some other cases, notably for Simple Object Access Protocol (SOAP) and Representational State Transfer (REST) services, an API comes as a specification of remote calls exposed to the API consumers.

An enterprise (e.g., a corporation) typically releases its API to third parties such that software developers can design products that are powered by the enterprise's services or shared data. To this end, a robust API for accessing Web based software applications or Web tools has become useful for enterprises practicing business models such as Software as a Service (SaaS) and infrastructure as a service (IaaS) since a majority of customers of these enterprises require interoperability with other SaaS applications, web services, and legacy systems. Furthermore, reliable performance of APIs is important for these enterprises to maintain services and customer loyalty, and developing technologies and tools to monitor API performance metrics for the services that these enterprises use is a key step toward achieving that goal.

Technologies and tools have been developed to monitor API performance metrics for the services that enterprises use, provide, or need through the released APIs. However, these technologies and tools provide users, such as software developers, with large amounts of performance data across the entire technology stack, from the underlying infrastructure resource metrics up through API level runtime parameters. The burden is then on the user, such as the software developer, to sift through this often voluminous performance data to pick out symptoms of potential performance bottlenecks and accordingly decides on an appropriate course of action. Although such monitoring and prompt decision making by a user are crucial from a performance perspective, they can be extremely time consuming. In addition, a need arises in providing a user notifications concerning the operating status of the released APIs, and alarm/alerts associated with the performance of the released APIs.

### SUMMARY OF THE INVENTION

In a first aspect of the invention, a method is provided for reporting performance data for a plurality of APIs. The method includes obtaining, by a computer system, one or more various measurements of performance of the APIs. The method further includes assessing, by the computer system, a performance status for each API based on the obtained one or more various measurements of performance. The method further includes receiving, by the computer system, a subscription request from a subscriber for a particular API of the APIs. The method further includes monitoring, by the computer system, performance of the particular API for a predetermined event that includes a change in at least one of the performance status for the particular API and the one or more various measurements of performance of the particular API. The method further includes comparing, by the computer system, the predetermined event to a table or database of information that includes notification and alert rules for the particular API that specify notification policies for various predetermined events. When the predetermined event matches at least one of the notification and alert rules, the method further includes sending, by the computer system, a notification or alert to the subscriber based on the notification policy for the at least one of the notification and alert rules.

In another aspect of the invention, a computer system is provided for reporting performance data for a plurality of APIs. The computer system includes a hardware memory device that stores program instructions. The computer system further includes a processor that executes the program instructions and causes the computer system to assess a performance status for each API of the APIs based on one or more various measurements of performance. The program instructions are further operable to cause the computer system to receive a subscription request from a subscriber for a particular API of the APIs. The program instructions are further operable to cause the computer system to monitor performance of the particular API for a predetermined event that includes a change in at least one of the performance status for the particular API and the one or more various measurements of performance of the particular API. When the predetermined event occurs, the program instructions are further operable to cause the computer system to register a time interval of the predetermined event. The program instructions are further operable to cause the computer system to compare the predetermined event, the performance status for the particular API, and the time interval for the predetermined event to a table or database of information that includes notification and alert rules for the particular API that specify notification policies for combinations of various predetermined events, various performance statuses, and corresponding length of time intervals. When the predetermined event, the performance status of the API, and the time interval match at least one of the notification and alert rules, the program instructions are further operable to cause the computer system to send a notification or alert to the subscriber based on the notification policy for the at least one of the notification and alert rules

In a further aspect of the invention, a computer program product is provide for that includes computer readable program instructions stored on non-transitory computer readable storage medium. The computer readable program instructions are operable to cause a computing device to assess a performance status for each API of a plurality of APIs based on one or more various measurements of performance. The computer readable program instructions are further operable to cause the computing device to receive a subscription request from a subscriber for a particular API of the APIs. The computer readable program instructions are further operable to cause the computing device to monitor performance of the particular API for a predetermined event that includes a change in at least one of the performance status for the particular API and the one or more various measurements of performance of the particular API. When the predetermined event occurs, the computer readable program instructions are further operable to cause the computing device to register a time interval of the predetermined event The computer readable program instructions are further operable to cause the computing device to compare the predetermined event, the performance status for the particular API, and the time interval for the predetermined event to a table or database of information that includes notification and alert rules for the particular API that specify notification policies for combinations of various predetermined events, various performance statuses, and corresponding length of time intervals. When the predetermined event, the performance status of the API, and the time interval match at least one of the notification and alert rules, the computer readable program instructions are further operable to cause the computing device to send a notification or alert to the subscriber based on the notification policy for the at least one of the notification and alert rules.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 is an illustrative architecture of a computing system implemented as embodiments of the present invention.

FIG. 2 shows an exemplary cloud computing environment in accordance with aspects of the invention.

FIGS. 3 and 4 show block diagrams in accordance with aspects of the invention.

FIGS. 5 and 6 show exemplary flows for processes in accordance with aspects of the invention.

FIGS. 7-13 show visual representations of an example of operation in accordance with aspects of the invention.

FIG. 14 shows an exemplary flow for a process in accordance with aspects of the invention.

### DETAILED DESCRIPTION OF ASPECTS OF THE INVENTION

The invention relates to software performance and, more particularly, to methods and systems for reporting on the operating status and performance alerts associated with released application programming interfaces (APIs). More specifically, implementations of the invention provide methods and systems for collecting and monitoring various measurements of performance of APIs such that an operating status of each API may be assessed, receiving a subscription to a notification and alert system, and executing one of a notification or an alert escalation process within an API monitoring environment. Advantageously, in embodiments, the methods and systems of the present invention may be implemented to improve API performance, attract developers, troubleshoot problems, and, ultimately, make better business decisions related to API infrastructure.

In embodiments, users on a network can access a website configured to collect and monitor various measurements of performance of APIs, which may then be assessed to determine a performance status of each API. The various measurements of performance of APIs may include a total number of request messages, a total number of errors, a number of developers, a number of applications in use, a total response time, a size of each request message, duration of request processing, a size of each message sent, longest response time, shortest response time, and others, and may be determined using various formulations known to those of skill in the art. For example, the determination of a total number of errors may include monitoring and keeping a running count of errors generated by each API. As another example, the determination of total response time may include the use of requests and time commands to measure the time of processing the request. By way of another example, the determination of size of each request message may include retrieving size data from the header of each message.

In embodiments, once the measurements of performance of APIs are assessed, a user can easily subscribe and unsubscribe to one or more notification services to receive notifications or alerts for the APIs that are based on the measurements of performance of the APIs. The notifications or alerts for the APIs can be distributed directly to a user that is subscribed with a web server or central management console (e.g., the web server or central management console may comprise the one or more notification services) or in accordance with a publish-subscribe model (e.g., the one or more notification services are external of the web server or central management console). In the direct distribution method of the present invention, the user may subscribe with the web server or central management console from which notification messages are desired. Alternatively, in the publish-subscribe model of the present invention, the web server or central management console (or “publisher”) publishes information to one or more external notification service (e.g., a notification service provided by a service provider) indicating that an event of interest has occurred. Further, the one or more external notification services can generate and transmit a corresponding event notification message to one or more users (or “subscribers”) that have subscribed to receive notification messages associated with an event of interest.

In both the direct notification and the publish-subscribe model, each of the subscribers registers with the one or more notification services to receive messages corresponding to one or more APIs. In embodiments, a message associated with the notification or alert can include a payload of data, such as a possible cause of the predetermined event and a possible corrective action. Furthermore, the payload of data may include additional details such as history or contextual information. The notification or alert message, however, can be formatted to omit the payload of data. Thus, a notification or alert message can indicate the occurrence of an event of interest without the additional overhead and processing associated with a typical message.

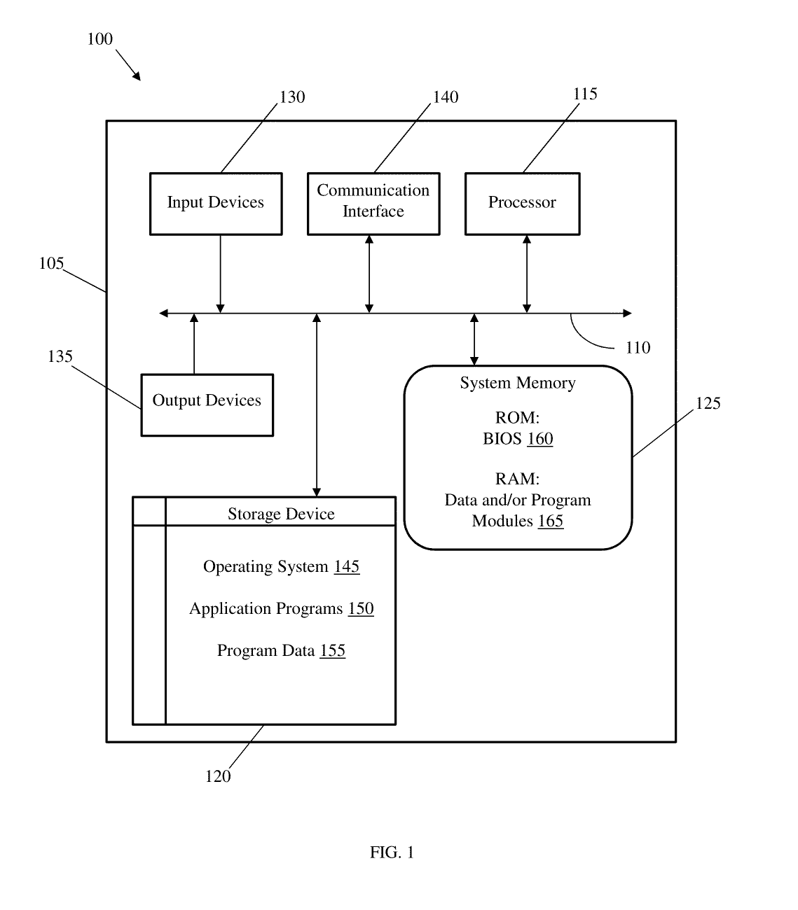

FIG. 1 is an illustrative architecture of a computing system 100 implemented as embodiments of the present invention. The computing system 100 is only one example of a suitable computing system and is not intended to suggest any limitation as to the scope of use or functionality of the invention. Also, computing system 100 should not be interpreted as having any dependency or requirement relating to any one or combination of components illustrated in computing system 100.

As shown in FIG. 1, computing system 100 includes a computing device 105. The computing device 105 can be resident on a network infrastructure such as within a cloud environment, or may be a separate independent computing device (e.g., a computing device of a third party service provider). The computing device 105 may include a bus 110, a processor 115, a storage device 120, a system memory (hardware device) 125, one or more input devices 130, one or more output devices 135, and a communication interface 140.

The bus 110 permits communication among the components of computing device 105. For example, bus 110 may be any of several types of bus structures including a memory bus or memory controller, a peripheral bus, and a local bus using any of a variety of bus architectures to provide one or more wired or wireless communication links or paths for transferring data and/or power to, from, or between various other components of computing device 105.

The processor 115 may be one or more conventional processors, microprocessors, or specialized dedicated processors that include processing circuitry operative to interpret and execute computer readable program instructions, such as program instructions for controlling the operation and performance of one or more of the various other components of computing device 105 for implementing the functionality, steps, and/or performance of the present invention. In embodiments, processor 115 interprets and executes the processes, steps, functions, and/or operations of the present invention, which may be operatively implemented by the computer readable program instructions. For example, the processor 115 may be configured to provide the functionality of collecting and monitoring various measurements of performance of APIs such that a performance status of each API may be assessed, receiving a subscription to a notification and alert system or publishing information to a notification service, and executing one of a notification or an alert escalation process within the API monitoring environment. In embodiments, processor 115 may receive input signals from one or more input devices 130 and/or drive output signals through one or more output devices 135. The input devices 130 may be, for example, a keyboard or touch sensitive user interface (UI) as further described below. The output devices 135 can be, for example, any display device, printer, etc., as further described below.

The storage device 120 may include removable/non-removable, volatile/non-volatile computer readable media, such as, but not limited to, non-transitory media such as magnetic and/or optical recording media and their corresponding drives. The drives and their associated computer readable media provide for storage of computer readable program instructions, data structures, program modules and other data for operation of computing device 105 in accordance with the different aspects of the present invention. In embodiments, storage device 120 may store operating system 145, application programs 150, and program data 155 in accordance with aspects of the present invention.

The system memory 125 may include one or more storage mediums, including for example, non-transitory media such as flash memory, permanent memory such as read-only memory (“ROM”), semi-permanent memory such as random access memory (“RAM”), any other suitable type of storage component, or any combination thereof. In some embodiments, an input/output system 160 (BIOS) including the basic routines that help to transfer information between the various other components of computing device 105, such as during start-up, may be stored in the ROM. Additionally, data and/or program modules 165, such as at least a portion of operating system 145, application programs 150, and/or program data 155, that are accessible to and/or presently being operated on by processor 115 may be contained in the RAM.

The one or more input devices 130 may include one or more mechanisms that permit an operator to input information to computing device 105, such as, but not limited to, a touch pad, dial, click wheel, scroll wheel, touch screen, one or more buttons (e.g., a keyboard), mouse, game controller, track ball, microphone, camera, proximity sensor, light detector, motion sensors, biometric sensor, and combinations thereof. The one or more output devices 135 may include one or more mechanisms that output information to an operator, such as, but not limited to, audio speakers, headphones, audio line-outs, visual displays, antennas, infrared ports, tactile feedback, printers, or combinations thereof.

The communication interface 140 may include any transceiver-like mechanism (e.g., a network interface, a network adapter, a modem, or combinations thereof) that enables computing device 105 to communicate with remote devices or systems, such as a mobile device or other computing devices such as, for example, a server in a networked environment, e.g., cloud environment. For example, computing device 105 may be connected to remote devices or systems via one or more local area networks (LAN) and/or one or more wide area networks (WAN) using communication interface 140.

As discussed herein, computing system 100 may be configured to collect and monitor various measurements of performance of APIs such that a performance status of each API may be assessed, receive a subscription to a notification and alert system or publish information to a notification service, and execute one of a notification or an alert escalation process within the API monitoring environment. In particular, computing device 105 may perform tasks (e.g., process, steps, methods and/or functionality) in response to processor 115 executing program instructions contained in a computer readable medium, such as system memory 125. The program instructions may be read into system memory 125 from another computer readable medium, such as data storage device 120, or from another device via the communication interface 140 or server within or outside of a cloud environment. In embodiments, an operator may interact with computing device 105 via the one or more input devices 130 and/or the one or more output devices 135 to facilitate performance of the tasks and/or realize the end results of such tasks in accordance with aspects of the present invention. In additional or alternative embodiments, hardwired circuitry may be used in place of or in combination with the program instructions to implement the tasks, e.g., steps, methods and/or functionality, consistent with the different aspects of the present invention. Thus, the steps, methods and/or functionality disclosed herein can be implemented in any combination of hardware circuitry and software.

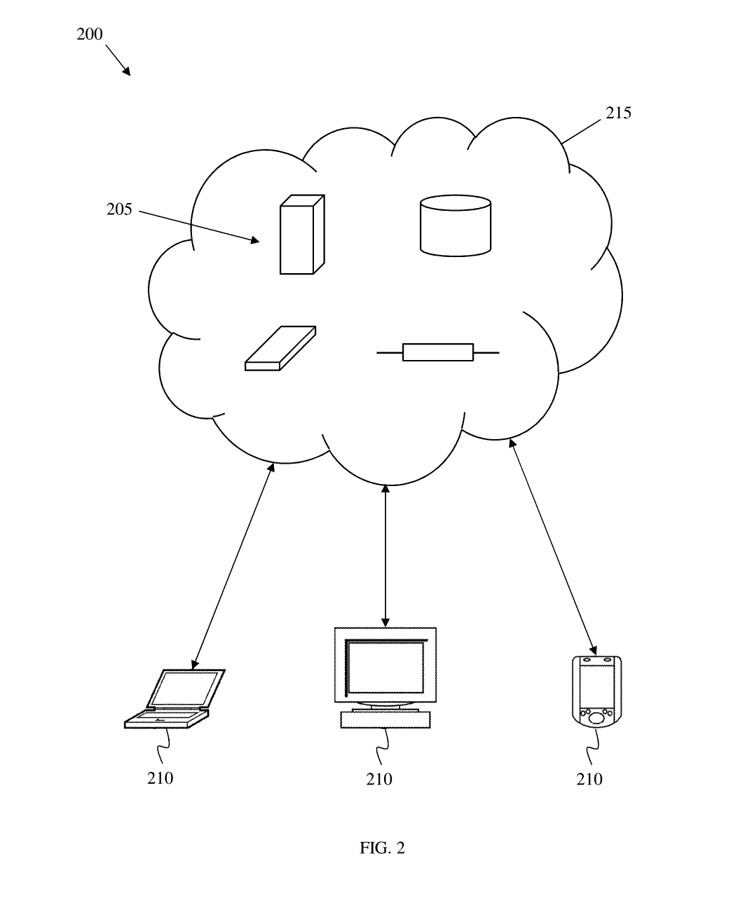

FIG. 2 shows an exemplary cloud computing environment 200. Cloud computing is a computing model that enables convenient, on-demand network access to a shared pool of configurable computing resources, e.g., networks, servers, processing, storage, applications, and services, that can be provisioned and released rapidly, dynamically, and with minimal management efforts and/or interaction with the service provider. In embodiments, one or more aspects, functions and/or processes described herein may be performed and/or provided via cloud computing environment 200.

As depicted in FIG. 2, cloud computing environment 200 includes cloud resources 205 that are made available to client devices 210 via a network 215, such as the Internet. Cloud resources 205 can include a variety of hardware and/or software computing resources, such as servers, databases, storage, networks, applications, and platforms. Cloud resources 205 may be on a single network or a distributed network. Cloud resources 205 may be distributed across multiple cloud computing systems and/or individual network enabled computing devices. Client devices 210 may comprise any suitable type of network-enabled computing device, such as servers, desktop computers, laptop computers, handheld computers (e.g., smartphones, tablet computers), set top boxes, and network-enabled hard drives. Cloud resources 205 are typically provided and maintained by a service provider so that a client does not need to maintain resources on a local client device 210. In embodiments, cloud resources 205 may includes one or more computing system 100 of FIG. 1 that is specifically adapted to perform one or more of the functions and/or processes described herein.

Cloud computing environment 200 may be configured such that cloud resources 205 provide computing resources to client devices 210 through a variety of service models, such as Software as a Service (SaaS), Platforms as a service (PaaS), Infrastructure as a Service (IaaS), and/or any other cloud service models. Cloud resources 205 may be configured, in some cases, to provide multiple service models to a client device 210. For example, cloud resources 205 can provide both SaaS and IaaS to a client device 210. Cloud resources 205 may be configured, in some cases, to provide different service models to different client devices 210. For example, cloud resources 205 can provide SaaS to a first client device 210 and PaaS to a second client device 210.

Cloud computing environment 200 may be configured such that cloud resources 205 provide computing resources to client devices 210 through a variety of deployment models, such as public, private, community, hybrid, and/or any other cloud deployment model. Cloud resources 205 may be configured, in some cases, to support multiple deployment models. For example, cloud resources 205 can provide one set of computing resources through a public deployment model and another set of computing resources through a private deployment model.

One or more cloud resources 205 may be conceptually structured in multiple layers. In one example, the layers include a firmware and hardware layer, a kernel layer, an infrastructure service layer, a platform service layer, and an application service layer. The firmware and hardware layer may be the lowest layer upon which the other layers are built, and may include generic contributing nodes (e.g., data centers, computers, and storage devices) geographically distributed across the Internet and provide the physical resources for implementing the upper layers of the cloud service provider. The kernel layer is above the firmware and hardware layer and may include an operating system and/or virtual machine manager that host the cloud infrastructure services. The kernel layer controls and communicates with the underlying firmware and hardware layer through one or more hardware/firmware-level APIs. The infrastructure service layer is above the kernel layer and may include virtualized resources, such as virtual machines, virtual storage (e.g., virtual disks), virtual network appliances (e.g., firewalls), and so on. The infrastructure service layer may also include virtualized services, such as database services, networking services, file system services, web hosting services, load balancing services, message queue services, map services, e-mail services, and so on. The platform service layer is above the infrastructure service layer and may include platforms and application frameworks that provide platform services, such as an environment for running virtual machines or a framework for developing and launching a particular type of software application. The application service layer is above the platform service layer and may include a software application installed on one or more virtual machines or deployed in an application framework in the platform service layer. The software application can also communicate with one or more infrastructure service components (e.g., firewalls, databases, web servers, etc.) in the infrastructure service layer.

In another example, one or more cloud resources 205 may be conceptually structured in functional abstraction layers including a hardware and software layer, a virtualization layer, a management layer, and a workloads layer. The hardware and software layer may include hardware and software components such as mainframes, RISC (reduced instruction set computer) architecture based servers, storage devices, networks and networking components, application server software, and database software. The virtualization layer may include virtual entities such as virtual servers, virtual storage, virtual networks, virtual applications, and virtual clients. The management layer may provide functions such as resource provisioning, metering and pricing, security, user portals, service level management, and service level agreement planning and fulfillment. The workloads layer may provide functions for which the cloud computing environment is utilized, such as mapping and navigation, software development and lifecycle management, data analytics and processing, and transaction processing.

In embodiments, software and/or hardware that performs one or more of the aspects, functions and/or processes described herein may be accessed and/or utilized by a client (e.g., an enterprise or an end user) as one or more of an SaaS, PaaS and IaaS model in one or more of a private, community, public, and hybrid cloud. Moreover, although this disclosure includes a description of cloud computing, the systems and methods described herein are not limited to cloud computing and instead can be implemented on any suitable computing environment.

Cloud resources 205 may be configured to provide a variety of functionality that involves user interaction. Accordingly, a user interface (UI) can be provided for communicating with cloud resources 205 and/or performing tasks associated with cloud resources 205. The UI can be accessed via a client device 210 in communication with cloud resources 205. The UI can be configured to operate in a variety of client modes, including a fat client mode, a thin client mode, or a hybrid client mode, depending on the storage and processing capabilities of cloud resources 205 and/or client device 210. Therefore, a UI can be implemented as a standalone application operating at the client device in some embodiments. In other embodiments, a web browser-based portal can be used to provide the UI. Any other configuration to access cloud resources 205 can also be used in various implementations.

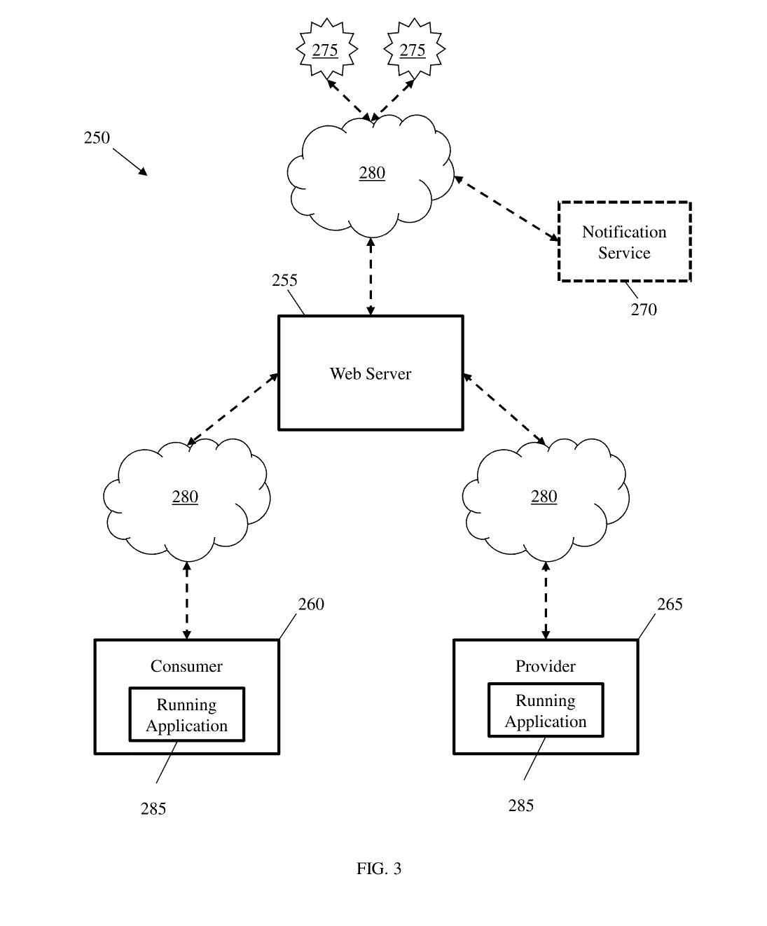

FIG. 3 shows a block diagram in accordance with some aspects of the invention. More specifically, FIG. 3 shows a functional block diagram that illustrates functionality of some aspects of the invention. In embodiments, FIG. 3 depicts system 250 comprising a web server 255 in communication with a consumer computing device 260, a provider computing device 265, a optional notification service 270, and one or more subscribers 275 via a network 280 (e.g., the Internet, a local area network, a wide area network and/or a wireless network). In embodiments, system 250 may also include any devices (not shown) configured to be used in a data center, cloud environment, or other network devices, such as routers, servers, or mobile devices. The web server 225 may be, for example, either the hardware (e.g., computing device 105 described with respect to FIG. 1) and/or the software (e.g., a computer application or program) that is configured to deliver web content (e.g., hosting of a website) that can be accessed through the network 280.

In embodiments, the consumer computing device 260 may be configured to communicate with the provider computing device 265 to request a particular functionality or obtain one more sets of data (e.g., car dealership data). For example, the consumer computing device 260 may communicate with the provider computing device 265 using an API through the web server 255. More specifically, consumer computing device 260 may be configured to send a JavaScript request for procuring a particular functionality or obtaining one or more data sets to the web server 255 via the network 280, and a Java Database Connectivity (JDBC) API on the web server 255 may forward the data request to the provider computing device 265 via the network 280 for requesting the particular functionality or retrieving the one or more data sets.

In embodiments, the web server 255 may be configured to send notifications or alerts for the APIs directly to a user (e.g., subscribers 275) that is subscribed with the web server 255. For example, the web server 255 may comprise the functionality of a notification service to provide notifications or alerts to one or more subscribers. Alternatively, in accordance with a publish-subscribe model the web server 255 may be configured to publish notifications or alerts for the APIs through the notification service 270. For example, when the web server 255 has a notification or alert to be published, it posts the message to the notification service 270 via an API exposed by the notification service 270. The notification service 270 will then determine from information in a subscription database which subscribers 275 should receive the notification or alert. For example, the subscription database may include information about each subscriber 275 that comprises the APIs and/or types of notifications or alerts to which the subscriber 275 has subscribed. Once the subscribers 275 to which the notification or alert is to be published have been determined, the notification service 270 will deliver a copy of the notification or alert to each of the subscribers 275 in a message.

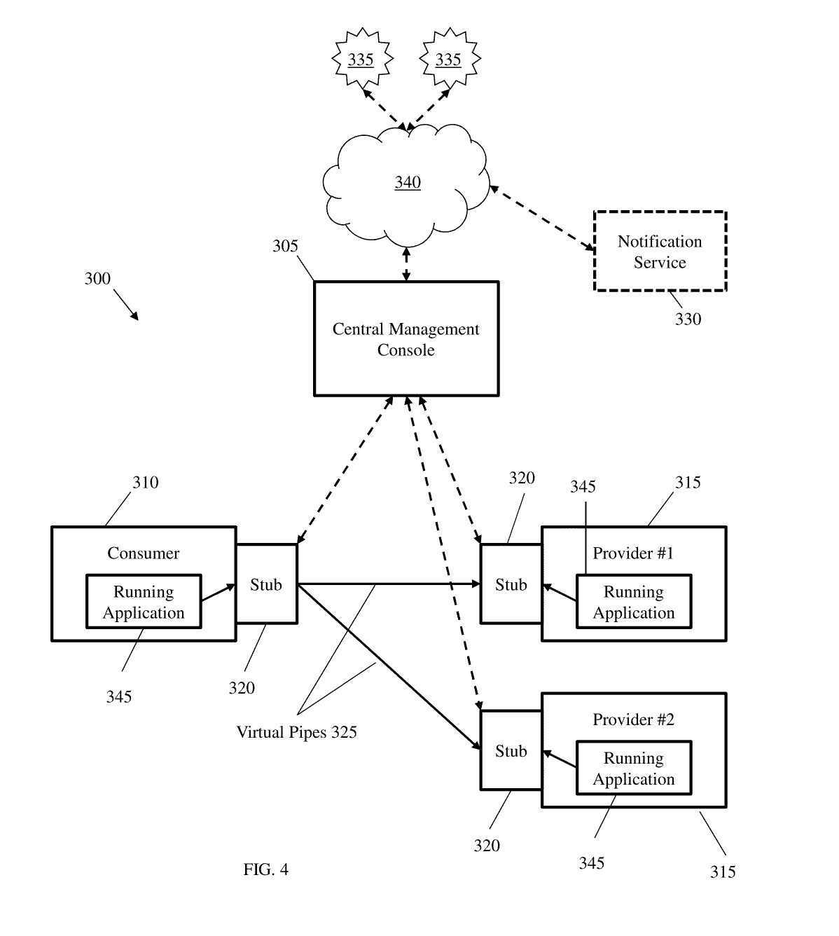

FIG. 4 shows a block diagram in accordance with other aspects of the invention. More specifically, FIG. 4 shows a functional block diagram 300 that illustrates functionality of other aspects of the invention. In embodiments, FIG. 4 depicts system 300 comprising central management console 305, consumer computing device 310, provider computing devices 315, stubs 320, and virtual pipes 325. In embodiments, system 300 may also include any devices (not shown) configured to be used in a data center, cloud environment, or other network devices, such as routers, servers, or mobile devices. Central management console 305 may be a computing device (e.g., computing device 105 described with respect to FIG. 1) operable to manage and communicate with stubs 320 installed on multiple other computing devices (e.g., consumer computing device 310 and/or provider computing devices 315 such as a computing device 105 described with respect to FIG. 1) over a network. For example, central management console 305 may be a standalone computing device, a collection of computing devices in a single location (e.g., a server rack), or a collection of computing devices in a cloud infrastructure (e.g., cloud computing environment 200 described with respect to FIG. 2). In embodiments, central management console 305 includes software and/or hardware for real time activity monitoring and managing data exchanges between multiple other computing devices through the use of stubs 320. For example, central management console 305 may operate using a server based application configured for system virtualization and/or cloud management.

In embodiments, central management console 305 may be configured to manage secure data exchanges and shared network information utilizing stubs 320 (e.g., virtual API interface) installed on one or more computing devices. For example, central management console 305 may be configured to instruct stubs 320 installed on consumer computing device 310 and/or provider computing devices 315 to perform secure data exchanges by establishing virtual pipes 325. In embodiments, provider computing devices 315 may be configured to provide a service such as to one or more consumer computing device(s) 310; whereas consumer computing device 310 may be configured to consume the service of provider computing devices 315. For example, consumer computing device 310 may request information or request an action to be performed by provider computing devices 315 through an API exposed by the provider.

In embodiments, the central management console 305 may also be in communication with an optional notification service 330 and one or more subscribers 335 via a network 340 (e.g., the Internet, a local area network, a wide area network and/or a wireless network). In accordance with these aspects of the present invention, the central management console 305 may be configured to send notifications or alerts for the APIs directly to a user (e.g., subscribers 335) that is subscribed with the central management console 305. For example, the central management console 305 may comprise the functionality of a notification service to provide notifications or alerts to one or more subscribers. Alternatively, in accordance with a publish-subscribe model the central management console 305 may be configured to publish notifications or alerts for the APIs through the notification service 330. For example, when the central management console 305 has a notification or alert to be published, it posts the message to the notification service 330 via an API exposed by the notification service 330. The notification service 330 will then determine from information in a subscription database which subscribers 335 should receive the notification or alert. For example, the subscription database may include information about each subscriber 335 that comprises the APIs and/or types of notifications or alerts to which the subscriber 335 has subscribed. Once the subscribers 335 to which the notification or alert is to be published have been determined, the notification service 330 will deliver a copy of the notification or alert to each of the subscribers 335 in a message.

In embodiments, stubs 320 may be a predefined combination of generated program code and configurations stored and/or run on various computing devices. For example, stubs 320 may be software libraries or in process agents with security protections abstracted from hardware and embedded in a virtual layer. In embodiments, the libraries may include specifications for routines, data structures, object classes, and variables. In embodiments, stubs 320 may be software defined virtual API interfaces that are designed to ensure safe, consistent, efficient, and fully audited communications between processes for one or more running applications 345 such as an exchange of data. For example, running applications 345 utilize APIs that specify how the running applications 345 should interact with each other in order to share and process content between computing devices. In embodiments, each running application 345 on a particular computing device may have a unique stub responsible for securely exchanging data related to that running application 345.

In embodiments, stubs 320 may provide abstraction at a web service call level of running applications 345. For example, stubs 320 may provide a web service abstraction layer based on named components and relative Uniform Resource Identifiers (URI), with API-defined headers and payloads. Advantageously, stubs 320 may convert an API web service call received from running applications 345 into a raw HTTP call and transmit to a destination based on injected rules, routing information, and load balancing information received from central management console 305.

In embodiments, stubs 320 may be customized for a particular running application 345 or may be a generic stub to be used with multiple different running applications 345. For example, multiple running applications 345 may use a shared stub library to handle API web service calls. In embodiments, running applications 345 may have multiple instances of the application running and may have a stub for each instance, such that each instance on a single computing device may be recognized as one logical endpoint by central management console 305. In embodiments, stubs 320 may provide abstracted consistent security across multiple programming languages. For example, stubs 320 may be implemented in different computer languages based on the language used in running applications 345 (e.g., JAVA, C++, SQL, etc.). For example, running applications 345 based in JAVA may be provided with a JAVA stubs, such that the stub may be configured to understand the API web service calls from the JAVA running applications 345 and is capable of performing the called functions.

In embodiments, stubs 320 may provide a single level abstraction for establishing secure virtual pipes 325 (e.g., virtual connections such as TCP/IP connections) for the exchange of data directly between computing devices. For example, when running applications 345 on a first computing device initiates a web service call, the web service call may be redirected by stubs 320 on the first computing device, such that those stubs 320 will process the web service call. In embodiments, stubs 320 may process a web service call from running applications 345 by converting the web service call into raw HTML, encoding the HTML, and transmitting the HTML data to a destination endpoint.

In embodiments, stubs 320 may also act as a module for handling rest calls from other devices, forming http requests, processing, listening for requests, and responding to requests. For example, running applications 345 may make an API web service call and stubs 320 for the particular running applications 345 may handle all the steps prior to transmitting the data, such as encryption, addressing, throttling, and/or metering of the API call. Similarly, if an endpoint computing device (e.g., a computing device receiving the API call) has a stub, then stubs 320 for the endpoint computing device may handle all the steps prior to handing the API web service call off to the appropriate running applications 345. For example, stubs 320 for the endpoint computing device will perform authentication, handshaking, decryption of the received data, and/or direct the received data to the proper running applications 345.

Continuing with respect to FIGS. 3 and 4, in embodiments, the consumer computing devices 260 and 310, provider computing devices 265 and 315 and, and/or stubs 320 may provide data to the webs server 255 or central management console 305 respectively for customized monitoring and control purposes. For example, the consumer computing devices 260 and 310, provider computing devices 265 and 315 and, and/or stubs 320 may provide live performance metrics and traffic information to the webs server 255 or central management console 305 respectively. The live performance metrics and traffic information may include various measurements of performance of APIs for running applications 285 and 345 on the consumer computing devices 260 and 310 and/or provider computing devices 265 and 315. In embodiments, the various measurements of performance of APIs may include: (i) a total number of request messages, (ii) a total number of errors, (iii) a number of developers, (iv) a number of applications in use, (v) a total response time, (vi) a size of each request message, (vii) duration of request processing, (viii) a size of each message sent, (ix) longest response time, (x) shortest response time, and others.

In embodiments, using the live performance metrics and traffic information provided by the consumer computing devices 260 and 310, provider computing devices 265 and 315 and, and/or stubs 320, the webs server 255 or central management console 305 may assess the various measurements of performance of APIs to determine a performance status of each API. For example, the webs server 255 or central management console 305 may be configured to run a health determination process for determining a quantifiable health metric indicative of each API's “health” that is either weighted or non-weighted using health metric techniques known to those of skill in the art. In additional embodiments, the central management console 305 may be configured to use the live performance metrics and traffic information to modify the rules transmitted to stubs 320 to enable throttling of data, metering of data, pause and/or resume operation. Also, in additional embodiments, central management console 305 may instruct stubs 320 to add tagging/attributes to enable monitoring flows to create real time visualizations of the network and employ virtualization testing. For example, central management console 305 may track communications between computing devices without adding information to the data payload.

In embodiments, the webs server 255 or central management console 305 may be further configured to generate a GUI built into a browser using programming language, such as HyperText Markup Language, tool kits, e.g., open source modular JavaScript library, such as Dojo toolkits, and/or widgets, such as website or application widgets (e.g., a GUI displayed on a computing device 105 as discussed with respect to FIG. 1) to visualize and allow for interaction of the API and performance status of each API. For example the webs server 255 or central management console 305 may be configured to visualize the API and performance status of each API in a GUI comprising a dashboard with status indicators for each API. Additionally, in embodiments, the webs server 255 or central management console 305 may be configured to allow a user to use a syntax search to search for a particular API, select a historical time of the various APIs to change which various measurements of performance of APIs are being visualized in any given instance in time, drill down an retrieve greater detail concerning the methods of each API, and initiate a live API call from the GUI using one or more methods of an API of a running application 280 and 345 that return data in an open standard format used by the API for transmitting data between software applications.

In embodiments, the webs server 255 or central management console 305 may comprise the functionality to expose API methods with clear documentation and execute a live call to an API's method by using parameters exposed from the web service with a clear definition of what each parameter serves. In additional embodiments, a node.js server (not shown) may be configured to expose the API methods to the webs server 255 or central management console 305 using authentication services to verify user access to the methods. For example, a user trying to obtain additional detail regarding a particular method of an API may be required to provide authentication or user access credential to the node.js server threw the webs server 255 or central management console 305 for access to one or more methods of the API.

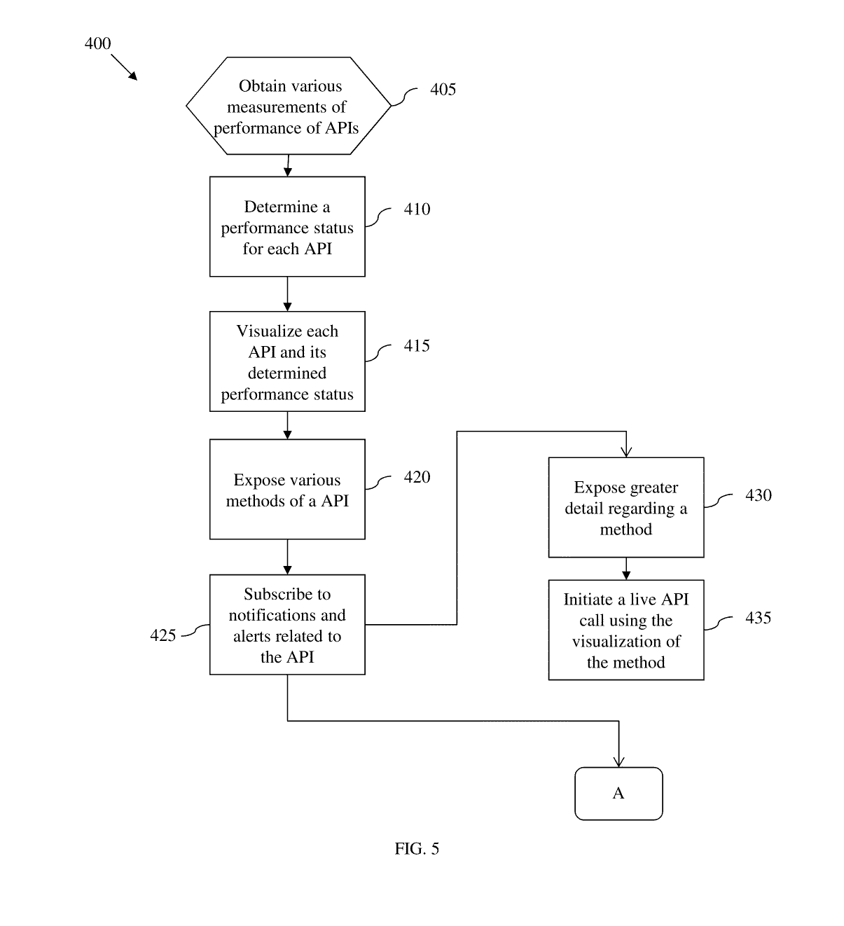

FIGS. 5, 6, and 14 depict exemplary flows for processes in accordance with aspects of the present invention. The exemplary flows can be illustrative of a system, a method, and/or a computer program product and related functionality implemented on the computing system of FIG. 1, in accordance with aspects of the present invention. The computer program product may include computer readable program instructions stored on computer readable storage medium (or media). The computer readable storage medium include the one or more storage medium as described with regard to FIG. 1, e.g., non-transitory media, a tangible device, etc. The method, and/or computer program product implementing the flows of FIGS. 5, 6, and 12 can be downloaded to respective computing/processing devices, e.g., computing system of FIG. 1 as already described herein, or implemented on a cloud infrastructure as described with regard to FIG. 2. Accordingly, the processes associated with each flow of the present invention can be implemented by special purpose hardware-based systems that perform the specified functions or acts or carry out combinations of special purpose hardware and computer instructions.

FIG. 5 is a flow diagram illustrating a process 400 for assessing and displaying various measurements of performance of APIs on one or more computing devices in accordance with embodiments of the present invention. At step 405, various measurements of performance of the APIs may be obtained. For example, various measurements of performance of APIs may be obtained from the consumer computing devices, provider computing devices, and/or stubs (e.g., as described with respect to FIGS. 3 and 4) and saved into a database at the web server or central management console (e.g., as described with respect to FIGS. 3 and 4). In embodiments, the various measurements may be saved in the database in such a manner that the various measurements of performance are linked with its respective source stub and includes date and time stamps. For example, the various measurements of performance may be saved with metadata that comprises the source stub of the data and/or date and time information for the data.

At step 410, a performance status may be determined for each API. For example, the web server or central management console may be configured to run a health determination process for determining a quantifiable health metric indicative of each API's “health” that is either weighted or non-weighted using health metric techniques know to those of skill in the art. For example, the web server or central management console may be configured to analyze the various measurements of performance provided for each API, and determine a quantifiable health metric for each API based on the analysis of the various measurements of performance provided for each API.

In embodiments, the standard definitions for the various measurements of performance for the API may include (i) a total number of request messages, (ii) a total number of errors, (iii) a number of developers, (iv) a number of applications in use, (v) a total response time, (vi) a size of each request message, (vii) duration of request processing, (viii) a size of each message sent, (ix) longest response time, (x) shortest response time, and others. In embodiments, the quantifiable health metric provided for the API may be determined based on all measurements being equally important (e.g., non-weighted). However, in additional or alternative embodiments, weights may be applied to one or more of the standard definitions for the various measurements of performance, for example, using a multiplier for establishing priority of one measurement over another (e.g., weighted).

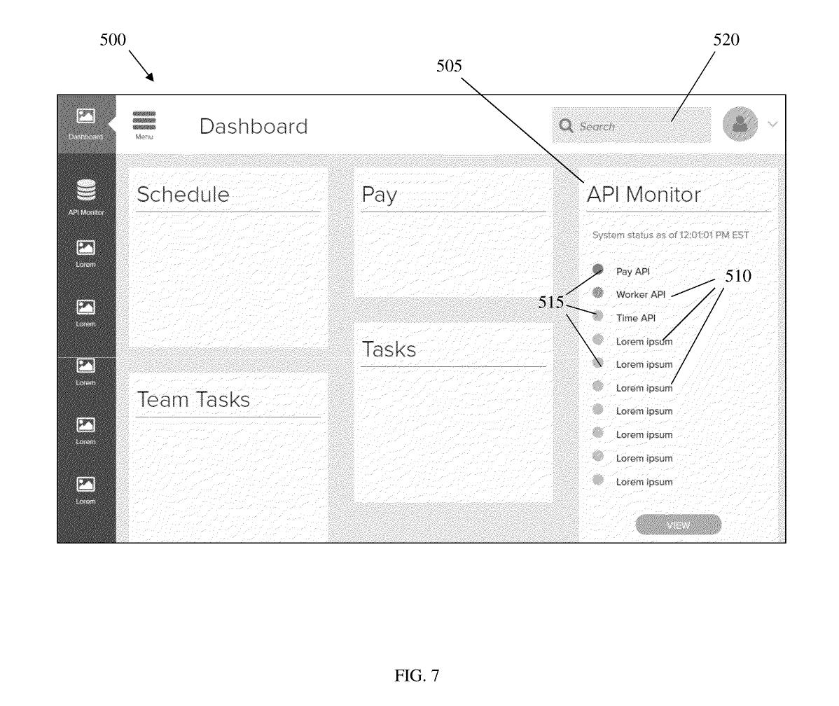

At step 415, each API and its determined quantifiable health metric may be visualized or illustrated. In embodiments, the visualization or illustration may be displayed as a GUI on a computing device (e.g., output devices 135 of computing device 105 as discussed with respect to FIG. 1). For example, the GUI may include a dashboard comprising each API, a visual indicator of the quantifiable health metric for each API, and a search bar for initiating a search for one or more APIs, as discussed in detail herein with reference to FIG. 7.

At step 420, each API may be selected or searched to drill down into or expose greater detail regarding each API. For example, selection or search of the API may open an additional window comprising a performance status as of a particular time, various measurements of performance, a mechanism for subscribing to the API, a history mechanism for navigating through time such that the various measurements of performance may be seen at different instances in time, and various methods utilized by the API, as discussed in detail herein with reference to FIGS. 7-10 and 12.

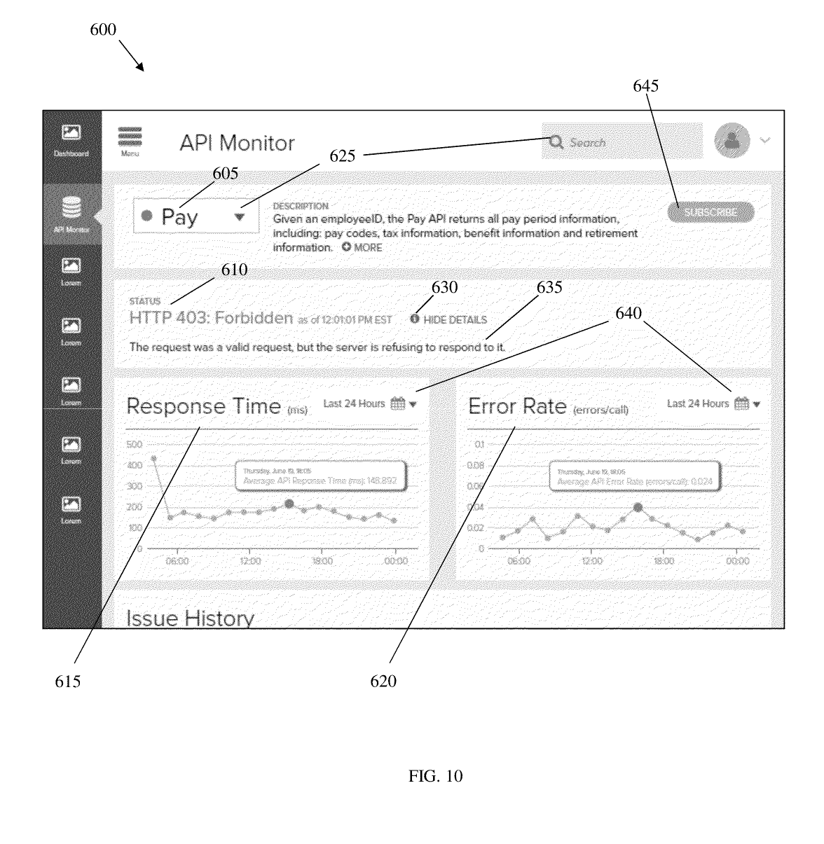

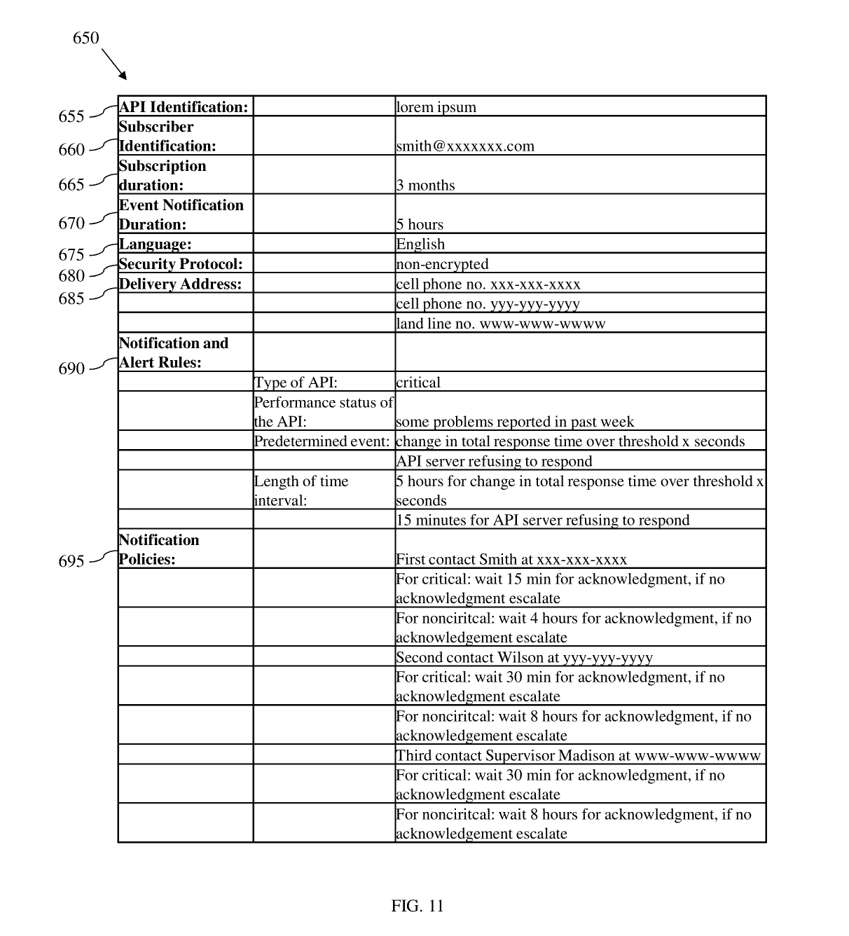

At step 425, the mechanism for subscribing to the API may be selected by a user to subscribe (or unsubscribe) to a notification service for receiving notifications regarding the operating status of the API and performance alerts associated with the API. For example, selection of the mechanism for subscribing to the API may open an additional window comprising an interface for entering and modifying subscription information. Subscription information may include the identification of the API, identification of the subscriber, subscription duration, event notification duration, language, security protocol, delivery address (e.g., address of the user's terminal device or mobile device), notification and alert rules, notification policies etc, as discussed in detail herein with reference to FIGS. 10 and 11. In embodiments, the notification policies may include the one or more delivery addresses and a corresponding priority order or hierarchy for sending the notifications or alarms.

After entering and modifying subscription information, the subscriber can transmit one or more subscribe messages to the notification service (e.g., the notification service functionality integrated with the webs server 255 or the central management console 305, or alternatively the notification service 270/330; FIGS. 3 and 4) indicating one or more APIs of interest. The one or more subscribe messages can include the identifier associated with the subscriber and the API to which the subscriber would like to subscribe. For example, a subscribe message can indicate that the subscriber identified as smith@xxxxxxx.com is requesting a subscription to the API lorem ipsum.

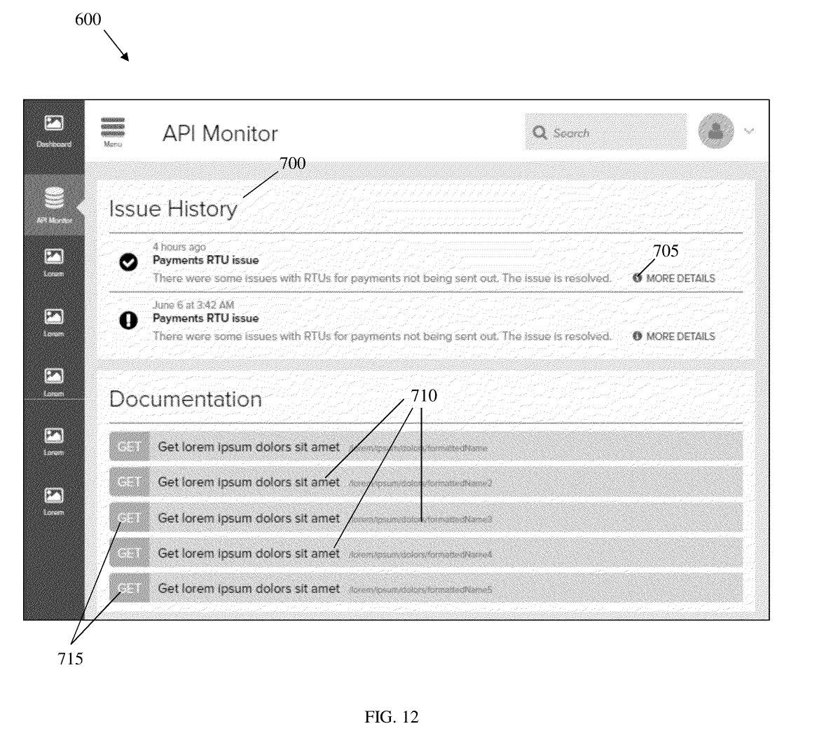

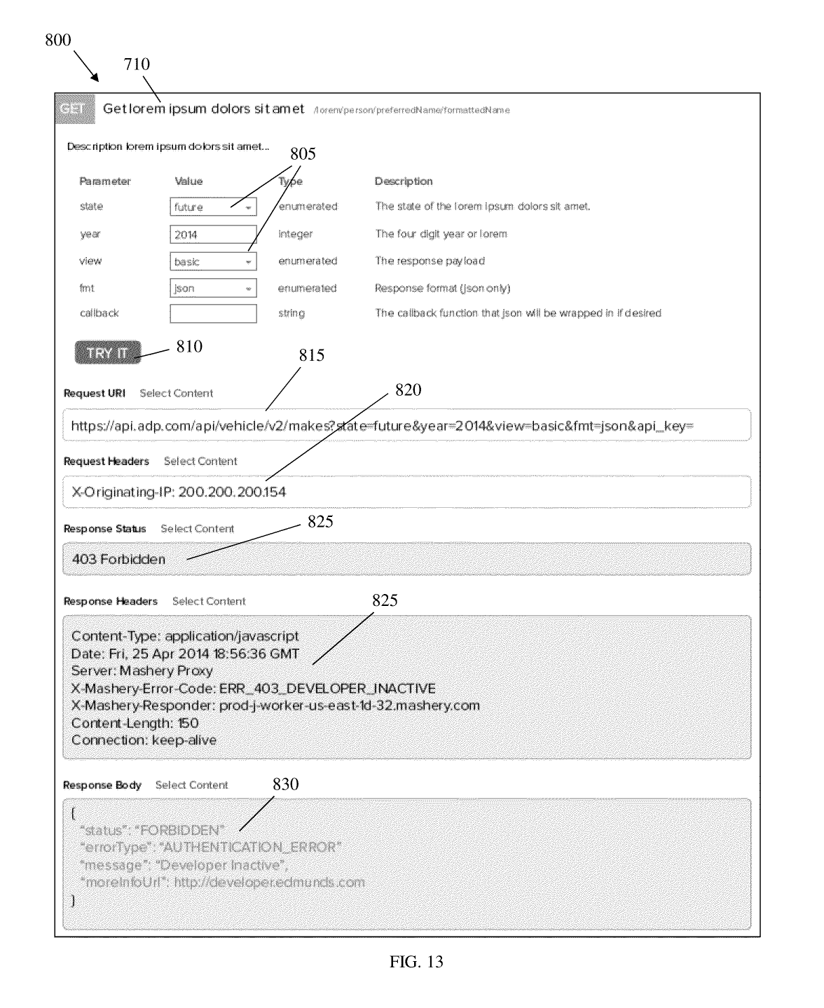

At step 430, each of the various methods may be selected to drill down into or expose greater detail regarding each method. For example, selection of a method may open an additional window comprising the purpose of method, the request URL for each method in XML and/or JSON format, request parameters of the method, error codes of the method, and any additional notes for the method, as discussed in detail herein with reference to FIGS. 12 and 13.

At step 435, a live API call may be initiated from the GUI using one or more methods of the selected API. In embodiments, the graphic user interface may be used by a user to select a method to initiate a live API call from the GUI using the method of the selected API of a running application that returns data in an open standard format used by the API for transmitting data between software applications, as discussed in detail herein with reference to FIG. 13.

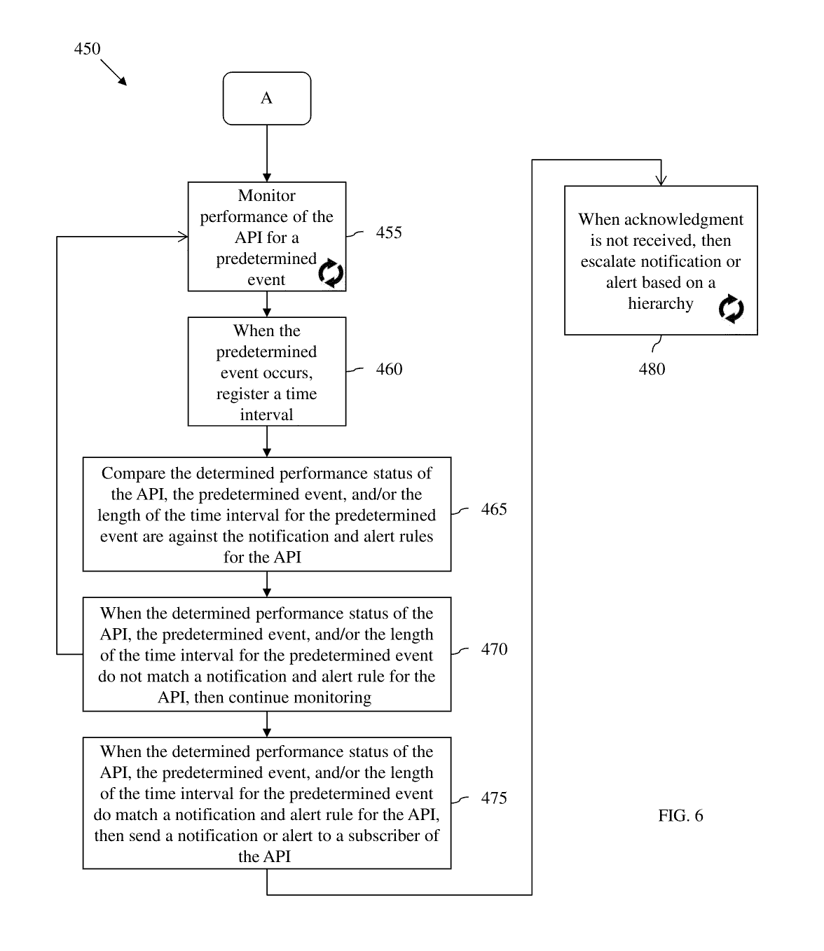

FIG. 6 is a flow diagram illustrating a process 450 for executing one of a notification or an alert escalation process within an API monitoring environment in accordance with embodiments of the present invention. At step 455, the performance of the API is monitored for a predetermined event. For example, the web server or central management console may be configured to perform monitoring of the performance of the API for a status change (e.g., a change in the performance status of the API, a change in the quantifiable health metric for the API and/or a change in one or more of the various measurements of performance provided for the API). As previously discussed with respect to step 410, the web server or central management console may be configured to analyze the various measurements of performance provided for the API, and determine the quantifiable health metric for the API based on the analysis of the various measurements of performance provided for the API.

At step 460, when the predetermined event occurs, e.g., if the API is no longer communicating with the system, then a clock registers a time interval of the predetermined event. For example, the web server or central management console may be configured to upon determination of the predetermined event, initiate a clock in order to track a time interval for the predetermined event. At step, 465, the determined performance status of the API, the predetermined event, and/or the length of the time interval for the predetermined event are compared against performance statuses, predetermined events, and/or corresponding lengths of time intervals specified in the notification and alert rules for the API. For example, the web server or central management console may be configured to compare the determined performance status of the API, the predetermined event, and/or the length of the time interval for the predetermined event to a table or database of information that includes notification and alert rules for the API that specify notification policies for various performance statuses, predetermined events, and/or corresponding lengths of time intervals. In embodiments, the notification and alert rules for the API may be provided by the developer of the API (e.g., the provider), the provider of the monitoring tool (e.g., a service provider) and/or subscribers by way of subscriber information. For example, the notification and alert rules for the API may be provided by the developer of the API, and a subscriber may pick and choose preferences for the notification and alert rules for the API by way of the subscriber information.

At step 470, when the determined performance status of the API, the predetermined event, and/or the length of the time interval for the predetermined event do not match a notification and alert rule for the API, then monitoring continues at step 455. For example, when the determined performance status of a non-critical API is determined as some problems reported within a specified time period, the predetermined event is a change in the total response time over a predetermined threshold, and the time interval of the problems being reported for an extended response time is two days, do not, alone or in combination, match a notification and alert rule for the API, the web server or central management console may be configured to continue monitoring the performance of the API at step 455.

On the other hand, at step 475, when the determined performance status of the API, the predetermined event, and/or the length of the time interval for the predetermined event do match a notification and alert rule for the API, then a notification is sent to the subscriber of the API, e.g., a first person or device in a hierarchy. For example, when the determined performance status of a critical API is determined as some problems reported within a specified time period, the predetermined event is a change in the total response time over a predetermined threshold, and the time interval of the problems being reported for an extended response time is one hour, alone or in combination, match a notification and alert rule for the API, a notification or alert is sent to the subscriber of the API, e.g., a first person or device in a hierarchy, based on the notification policies.

In embodiments, the notification or alert is sent based on the notification policies to the subscriber of the API directly by the web server or central management console using integrated notification service functionality. In other embodiments, the web server or central management console may be configured to forward or publish the existence of the match (e.g., a match between the determined performance status of the API, the predetermined event, and/or the length of the time interval for the predetermined event and a notification and alert rule for the API) to a notification service, e.g., a external notification service provided by a service provider. Thereafter, the external notification service may be configured to send the notification or alert based on the notification policies to the subscriber.

In embodiments, a person or device designated to receive a notification or alarm may receive such notification by the sending of an alert through a communication channel to a communication device or module of the person or device. The communication device or module may be, for examples, a pager, a telephone, voicemail system, email system with the appropriate transmission protocols used. In one embodiment, for example, the communication device may be cell phone and the notification or alert may be transmitted via short message service (SMS). In an alternative embodiment, communication device may be a client system capable of receiving emails that is coupled to a network and the notification or alert may be transmitted through network. In yet another embodiment, for example, communication device may be a pager coupled to wireless network and the alert may be transmitted through wireless network. In embodiments, other communication devices, and corresponding channels, may be used, for examples, electronic sign boards. Notifications are not limited to only a single communication device or channel. A notification or alert may be transmitted to multiple communication devices in parallel or in series.

In embodiments, a message associated with the notification or alert can include a payload of data, such as a possible cause of the predetermined event and a possible corrective action. Furthermore, the payload of data may include additional details such as history or contextual information. The notification or alert message, however, can be formatted to omit the payload of data. Thus, a notification or alert message can indicate the occurrence of an event of interest without the additional overhead and processing associated with a typical message.

At step 480, when an acknowledgment of the notification or alert is not received within a configurable amount of time, then the notification or alert may be escalated to another person or device in the hierarchy. This process may be repeated if an acknowledgement is not received within a same or different configurable amount of time until an acknowledgment is received. For example, when the web server or central management console, or the notification service do not receive an acknowledgement of the notification or alarm within a configurable amount of time, then the web server or central management console, or the notification service may be configured to escalate the notification or alert to another person or device in the hierarchy based on the notification policies. In an instance in which a notification or alert hierarchy is completed without receipt of an acknowledgement, then a failure to notify response may be generated that reports the failure to notify and corresponding notification or alert hierarchy followed by the system to a provider of the monitoring tool, e.g., a service provider.

FIGS. 7-13 show different determinations, assessments, manipulations, and modifications of various measurements of performance that may be performed and displayed to a user via the web server or central management console in a GUI. As shown in FIG. 7, the web server or central management console may be configured to generate an illustration 500 (e.g., a web page) having an API monitor 505 including various APIs 510 and visual indicators 515 of the quantifiable health metric for each API. In embodiments, the visual indicators 515 may be shown with lights having different colors, patterns, or textures such as a stop light pattern such that viewing the lights provides a user with information regarding the health of each API, e.g., a red light may indicate to a user that the API has failed, a green light may indicate to a user that the API is fully functional, and yellow light may indicate to a user some problems have been experience with the API. To this end, the illustration 500 may be displayed as a GUI on a computing device (e.g., output devices 135 of computing device 105 as discussed with respect to FIG. 1) configured to receive user input and interaction.

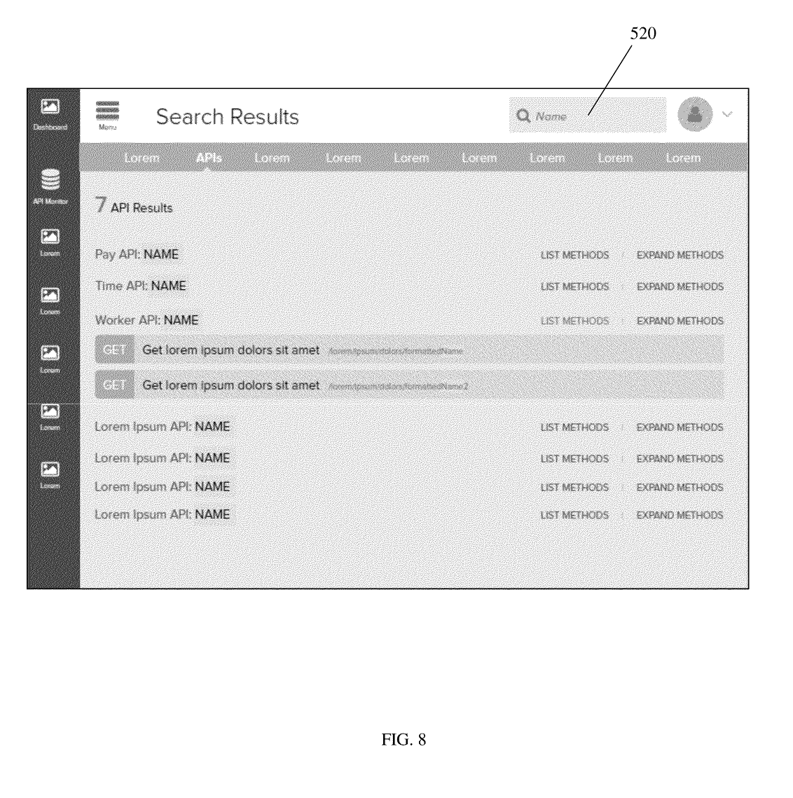

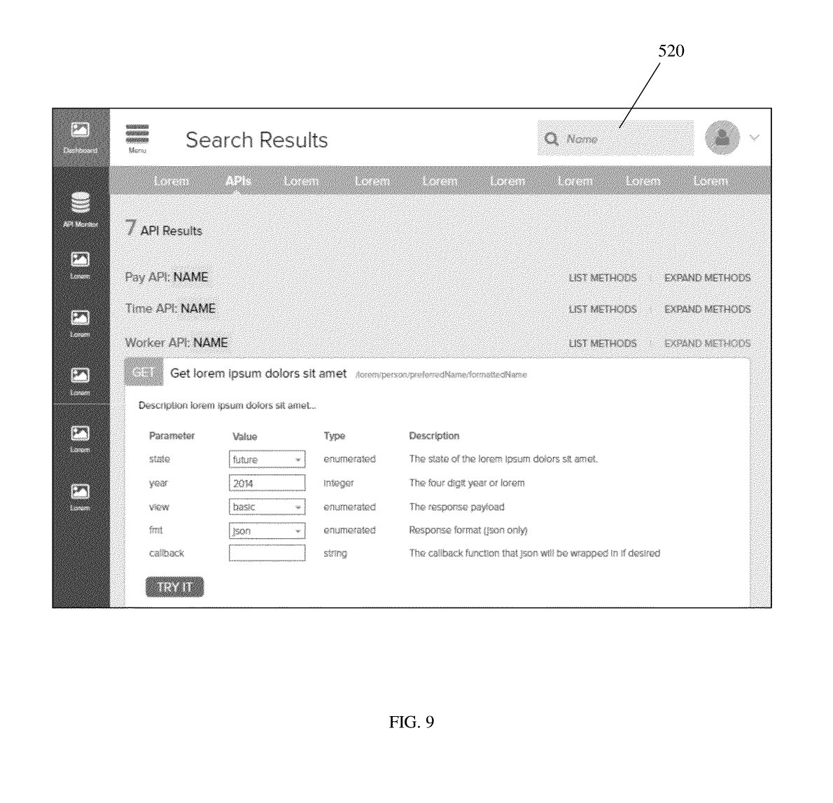

The illustration 500 may further include a search bar 520 for initiating a search (e.g., a syntax search) for one or more APIs. In embodiments, a user can utilize the search bar 520 to search for a specific API using keywords that can be compared to names of APIs within the dashboard, methods of various APIs, and comments of web services, as shown in FIGS. 8 and 9. For example, an API search result may be rendered within the web server or central management console based on the search of the keyword within the structure definition of an API. For example, a JSON schema definition may be stored in a database (e.g., a NoSQL database) in the following format:

Search for “name” within the .JSON file:

{

```
“$schema”: “http://json-schema.org/draft-04/schema#”,
  “title”: “Product”,
  “description”: “A name product from Acme's catalog”,
  “type”: “object”,
  “properties”: {
```

“id”: {

“description”: “The name identifier for a product”,
“type”: “integer”

},
“name”: {

“description”: “name of the product”,
“type”: “string”

},
“price”: {

“type”: “name”,
“minimum”: 0,
“exclusiveMinimum”: true

}

},
“required”: [“id”, “name”, “price”]

}

Accordingly, a user can utilize the search bar 520 to search in the database for a specific keyword (e.g., “name”) by issuing a query within all the fields of the JSON schema definitions stored in the database for each API.

In additional or alternative embodiments, a user can utilize the search bar 520 to execute a “FIND” command for a keyword in order to find the location of a folder storing the “api_schemaName_Definition.json”. Thereafter, the web server or management console knows the File Name and API method that has the keyword in any of the descriptions, parameters, or parameter descriptions themselves. Accordingly, only sections of the html/pgp/xml file tree that have the keyword executed with the find command will be rendered as a result of executing a search via the search bar 520.

In embodiments, the illustration 500 may further allow for visualization of detailed information for each API 510, as shown in FIG. 10. For example, each API 510 within the API monitor 505 may be selectable (e.g., clickable via an input device) or searchable, as described above with respect to the search bar 520, to cause the web server or central management console to generate an additional window 600 (e.g., another web page or pop up window having an API dossier) that illustrates additional information for each API that includes a description 605 of the API, a status 610 of the API, and various measurements of performance of the API including response times 615 and error rates 620. The description 605 includes a set of functions or routines performed by the API that accomplish a specific task or are allowed to interact with a specific software component. The status 610 includes the status of the API such as operating normally, performance issues, service disruption, and/or informational messages, as of a specific time. The response time 615 includes data points provided in a graphical representation that are representative of a length of time that it takes to get a response from an API over a span of time (e.g., the last 24 hours). Error rate 620 includes data points provided in a graphical representation that are representative of a number of errors incurred by the API over a span of time (e.g., the last 24 hours).

In embodiments, the additional window 600 may further include one or more mechanisms 625 (e.g., a pull down list and/or search bar) to switch to a different API directly from the additional window 600, rather than navigating back to the preceding web page comprising illustration 500. The drop down list may present the APIs in any order, for example the APIs may be presented in order of severity of status with service disruptions listed at the top of the list and operating normally listed towards the bottom of the list. The additional window 600 may also include the details 630 of the status 610, which may be accessed by an informational message 635 (e.g., clickable via an input device). For example, the details 630 may include a description of the HTTP response.

In embodiments, the additional window 600 may further include a history mechanism 640 that may be utilized via a user to manipulate the various measurements of performance of APIs to view snapshots of the various measurements of performance at a particular time, which may be then be updated and displayed. Additionally, the history mechanism 640 may be configured to allow a user to scroll through the various measurements of performance by day and/or hour. Accordingly, it should be understood that embodiments of the present invention allow a user to review historical and/or current data as a single snap shot or as a sequence of successive snapshots.

In embodiments, the additional window 600 may further include a mechanism 645 that may be utilized by a user for subscribing to a notification service for receiving notifications regarding the operating status of the API and performance alerts associated with the API. For example, selection of the mechanism 645 for subscribing to the API may open an additional window 650, as shown in FIG. 11, comprising an interface for entering and modifying subscription information. Subscription information may include the identification of the API 655, identification of the subscriber 660, subscription duration 665, event notification duration 670, language 675, security protocol 680, delivery address 685 (e.g., address of the user's terminal device or mobile device), notification and alert rules 690, notification policies 695, etc. In embodiments, the notification policies may include the one or more delivery addresses and a corresponding priority order or hierarchy for sending the notifications or alarms.

The additional window 650 opened via mechanism 643 may be an interface that is used by a user to configure API parameter monitoring, notification, escalation rules, and provide notification or alarm and organization of the data collected about the API. In one embodiment, the interface may be in the form of a web-based interface having inputs to populate the subscription information. The configured subscription information may additionally include what a user desires to be monitored with respect to the API (e.g., host IDs/addresses, host parameters, services, expected parameter values, frequency of monitoring, etc.). Additional parameters may include timing parameters, for example, time between failed responses, response times, and task processing times.

The notifications or alarms may be set up with various notification and escalation parameters that determine hierarchies and priorities. For example, a notification may be configured for transmission to one or more communications devices of a particular person. If that person does not acknowledge the notification in a predetermined period of time, a set of escalation parameters may be established to send the notification to the communication device(s) of another person or persons. Furthermore, the escalation of the notification may be prioritized based on a particular type of notification.

In embodiments, the notification parameters may include, for examples, notify on critical, notify on API down, notify on recovery, and notify on warning, time between notifications. The notify on critical parameter determines whether a contact is notified if an API is in a critical state. The notify on API down parameter determines whether notifications are sent to any contacts if the API is in a down state. The notify on recovery parameter determines whether notifications are sent to any contacts if the API is in a recovery state. The notify on warning parameter determines whether a contact will be notified if an API is in either a warning or an unknown state. Time between notifications or wait time is a number of time units to wait before re-notifying a contact or an escalated contact that an API is still down or not performing properly.

As previously discussed, if a notification is not acknowledged, it may be escalated based a set of escalation rules. The escalation rules may be based on configurable parameters such acknowledgment wait (e.g., the time delay between sending of the notification and receipt of acknowledgment before escalating the notification to the next level in the hierarchy), severity of the problem for which notification is being sent, and notification schedules for on-staff persons of a business site. Escalation parameters may also include, for examples: contact members, contact groups, contact schedule, contact means. The contact members parameter is used to establish the persons for the sending of a notification. Contact group is used to group one or more contact members together for the purpose of sending out notifications and recovery notifications. Contact schedule specifies the days and times for contact notification. Contact means determines which communications means (e.g., pager, email, phone, etc.) is used for notification.

As shown in FIG. 12, the additional window 600 may also include an issue history 700 that includes any issues experienced by the API over a span of a predefined period of time. The issue history 700 may also include expanded details of the issues, which may be accessed by an informational message 705 (e.g., clickable via an input device). The additional window 600 also include the methods 710 (e.g., a method for retrieving all user data specified in an API request, a method for retrieving individual records by record ID, a method for downloading a file attached to a record, etc.) utilized by the API for accessing running applications. It should be understood that the methods described above are merely examples and such methods can be any methods for use with APIs to cause an application to perform a process without departing from the spirit and scope of the present invention.

In embodiments, the additional window 600 may further comprise: (i) a mechanism (not shown) for listing the methods 710, e.g., in a particular order or sequence, (ii) a mechanism (not shown) for expanding the methods 710, e.g., a opening the methods to reveal additional information regarding each method such as the purpose of method, the request URL for each method in XML and/or JSON format, request parameters of the method, error codes of the method, and any additional notes for the method, and (iii) a mechanism 715 for obtaining a method 710, e.g., a selectable (e.g., clickable via an input device) mechanism to cause the web server or central management console to generate an additional window 800 (e.g., new web page or a pop up window) that illustrates implementation of a particular method, as shown in FIG. 13.

In accordance with aspects of the invention, the web server or central management console may comprise the functionality to expose the methods 710 with understandable documentation including parameters exposed from the web service with a definition of what each parameter serves. For example, a node.js server may be configured to expose the API methods to the web server or central management console using authentication services to verify user access to the methods. Accordingly, a user trying to obtain additional detail regarding a particular method of an API may be required to provide authentication or user access credential to the node.js server threw the web server or central management console for access to one or more methods of the API.

In embodiments, the additional window 800 may allow for executing a live API call from the GUI using one or more methods of the selected API of a running application that returns data in an open standard format used by the API for transmitting data between software applications, as shown in FIG. 13. For example, each mechanism 715 for obtaining a method 710 (shown in FIG. 12) may be selectable (e.g., clickable via an input device) to cause the web server or central management console to generate the additional window 800 (e.g., new web page or a pop up window) that illustrates implementation of the particular method 710 including parameters 805 for executing the method 710. In embodiments, each parameter 805 may be pre-populated with values for exemplary running of the method 710, or a user can modify the parameters 805 with their own select values. The additional window 800 may further comprise a mechanism 810 for executing the method 710, e.g., a selectable (e.g., clickable via an input device) mechanism to cause the web server or central management console to generate a call using the parameters 805 and returns data in an open standard format (e.g., XML or JSON) used by the API for transmitting data between software applications.

FIG. 13 also shows the additional window 800 may be configured to display in XML and/or JSON format the request URL 815 for the method, the request headers 820, the response status 825, which may be configured to provide additional detail on the health of the API, the response headers 825, and the response body 830. Accordingly, it should be understood that the methods and systems of the present invention are capable of testing each method of each API to determine functionality and additional health information regarding each API.

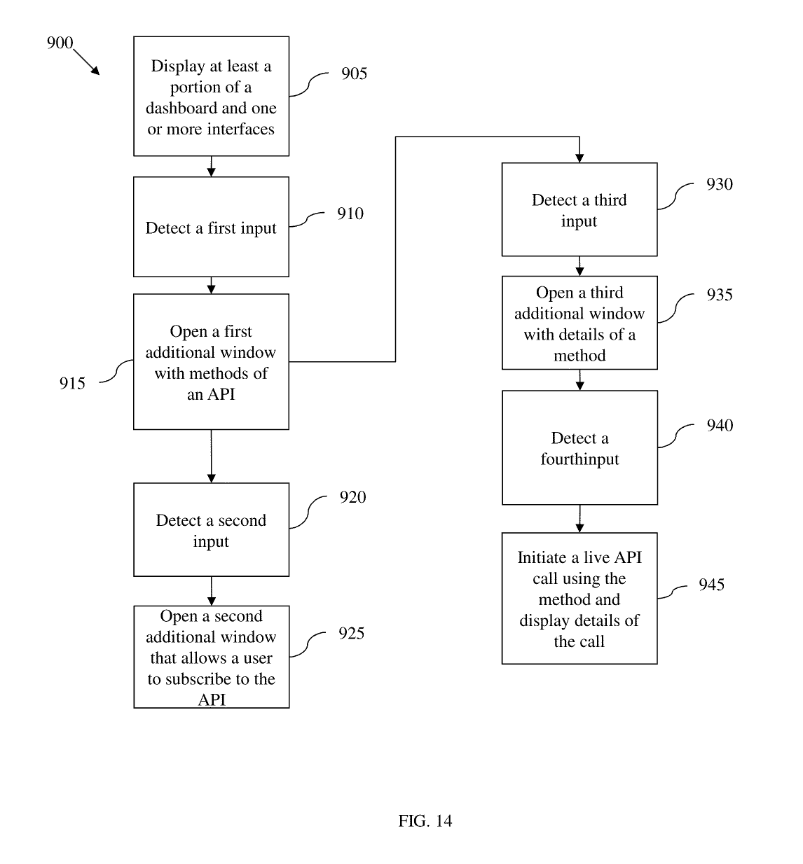

FIG. 14 is a flow diagram illustrating a process 900 for interacting with various measurements of performance of APIs on a computing device in accordance with embodiments of the present invention. At step 905, the computing device displays at least a portion of dashboard on a screen display with one or more interfaces. The dashboard comprises content such as various APIs and visual indicators of the quantifiable health metric for each API (e.g., APIs 510 and visual indicators 515, FIG. 7). In embodiments, at least a portion of the content may be displayed using modified text or graphics to distinguish a portion of the content from other portions of the content and provide a user with additional information concerning a portion of the content. For example, as described with respect to FIG. 7, the illustration 500 may be illustrated with distinguishing lights for the visual indicators to illustrate the quantifiable health metric for each API. In embodiments the various measurements of performance may be presented as a portion of a web page. In additional or alternative embodiments, the various measurements of performance may be presented as a hypertext markup language (HTML) or XML document.

At step 910, a first input (e.g., selection via input device 130, FIG. 1) may be detected on an API (e.g., an API 510, FIG. 7) or as a search inquiry (e.g., search bar 520) in the displayed portion of the dashboard. At step 915, in response to detecting the first input, at least a portion of a first additional window may be opened that illustrates additional information for the API that was selected or searched via the first input. The additional information may include a description of the API, a status of the API, and various measurements of performance of the API including response times and error rates. The additional information may further include any issues with the API and the methods (e.g., a method for retrieving all user data specified in an API request, a method for retrieving individual records by record ID, a method for downloading a file attached to a record, etc.) utilized by the API for accessing running applications.

While the portion of the first additional window is displayed, at step 920, a second input (e.g., selection via input device 130, FIG. 1) may be detected on a mechanism (e.g., mechanism 645, FIG. 10) in the displayed portion of the first additional window. At step 925, in response to detecting the second input, at least a portion of a second additional window may be opened that allows a user to subscribe (or unsubscribe) to a notification service for receiving notifications regarding the operating status of the API and performance alerts associated with the API. For example, selection of the mechanism by way of the second input may open the first additional window comprising an interface for entering and modifying subscription information. The subscription information may include the identification of the API, identification of the subscriber, subscription duration, event notification duration, language, security protocol, delivery address (e.g., address of the user's terminal device or mobile device), notification and alert rules, notification policies, etc.

While the portion of the first additional window is displayed, at step 930, a third input (e.g., selection via input device 130, FIG. 1) may be detected on a method (e.g., a method 710, FIG. 12) in the displayed portion of the first additional window. At step 935, in response to detecting the third input, at least a portion of a third additional window may be opened that illustrates additional information for the method such as parameters for executing the method.

While the portion of the third additional window is displayed, at step 940, a fourth input (e.g., selection via input device 130, FIG. 1) may be detected on a mechanism within a portion of the third additional window (e.g., mechanism 810, FIG. 13). At step 945, in response to detecting the fourth input, a call may be executed using the parameters of the method that returns data in an open standard format (e.g., XML or JSON) used by the API for transmitting data between software applications, as described with respect to FIG. 13.

In embodiments, displaying the one or more windows may comprise displaying the one or more windows on top of the displayed portion of the dashboard and one or more interfaces. For example, the one or more windows may be superimposed on top of the displayed portion of the dashboard and one or more interfaces. In some embodiments, the one or more windows may be semitransparent or opaque. In alternative embodiments, displaying the one or more windows may comprise opening the one or more windows in a separate web page.

As should be understood, aspects of the present invention allow for the measurements of performance to be collected and assessed for each API, the API and performance status of each API to be visualized and interacted with via a web based GUI, a subscription to a notification and alert system to be received, and one of a notification or an alert escalation process to be executed. More specifically, the systems and methods of the present invention allow for a user to assess the performance of APIs based on measurements of performance at an instance in time via a user friendly GUI and/or via a notification or an alert escalation process within an API monitoring environment, which allows the user to improve API performance, attract developers, troubleshoot problems, and, ultimately, make better business decisions related to API infrastructure.

In embodiments, the invention provides a computer-implemented method for measurements of performance to be collected and assessed for each API on a network infrastructure, and determinations, assessments, manipulations, and modifications of the various measurements of performance that may be performed and displayed to a user via a GUI. In this case, a computer system, such as computing system 100 (FIG. 1), can be provided on the network infrastructure and one or more systems, such as the web server or central management console, for performing the processes of the invention can be obtained (e.g., created, purchased, used, modified, etc.) and deployed on the network infrastructure.

In embodiments, the invention provides systems and methods that perform the process of the invention based on a subscription business model. To this end, a service provider, could create, maintain, support, etc., a computer infrastructure, such as computing system 100 (FIG. 1) that is configured to provide a service, for example, collecting and assessing measurements of performance for each API on a network infrastructure and/or providing subscription notifications or alarms concerning performance for APIs, to a consumer. In return, the service provider can receive payment from the consumer(s) under a subscription agreement such as a subscription price paid to have access to the computer infrastructure and/or service.

The foregoing examples have been provided merely for the purpose of explanation and are in no way to be construed as limiting of the present invention. While aspects of the present invention have been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although aspects of the present invention have been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A method of reporting performance data for application programming interfaces (APIs), comprising:
obtaining, by a computer system, one or more various measurements of performance of the APIs;
assessing, by the computer system, a performance status for each API based on the obtained one or more various measurements of performance;
receiving, by the computer system, a subscription request from a subscriber for a particular API of the APIs; and
monitoring, by the computer system, performance of the particular API for a predetermined event that includes a change in at least one of the performance status for the particular API and the one or more various measurements of performance of the particular API;
comparing, by the computer system, the predetermined event to a table or database of information that includes notification and alert rules for the particular API that specify notification policies for various predetermined events; and
when the predetermined event matches at least one of the notification and alert rules, sending, by the computer system, a notification or alert to the subscriber based on the notification policy for the at least one of the notification and alert rules.

2. The method of claim 1, wherein the one or more various measurements of performance of the APIs are obtained from stubs on one or more computing devices operably connected to a network.

3. The method of claim 2, further comprising:
displaying, by the computer system, the performance status for each API on a graphical user interface; and
receiving, by the computer system, a subscriber message including an identifier of the subscriber and an indication of the particular API to which the subscriber intends to subscribe.

4. The method of claim 1, wherein the assessing comprises determining a quantifiable health metric for each API that is indicative of the performance status for each API.

5. The method of claim 4, wherein the quantifiable health metric is either weighted or non-weighted.

6. The method of claim 5, wherein the predetermined event further includes a change in at least one of the performance status for the particular API, the one or more various measurements of performance of the particular API, and the quantifiable health metric.

7. The method of claim 1, further comprising when the predetermined event occurs, registering, by the computer system, a time interval of the predetermined event.

8. The method of claim 7, wherein the comparing further comprises comparing the predetermined event, the performance status for the particular API, and the time interval for the predetermined event to the table or database of the information that includes the notification and alert rules for the particular API that specify the notification policies for combinations of the various predetermined events, various performance statuses, and corresponding length of time intervals.

9. The method of claim 8, wherein when the predetermined event, the performance status for the particular API, and the time interval match at least one of the notification and alert rules, sending, by the computer system, the notification or alert to the subscriber based on the notification policy for the at least one of the notification and alert rules.

10. The method of claim 1, wherein at least the step of sending the notification or alert to the subscriber is provided by a service provider under a subscription agreement.

11. A computer system for reporting performance data for application programming interfaces (APIs), comprising:
a hardware memory device that stores program instructions; and
a processor that executes the program instructions and causes the computer system to:
assess a performance status for each API of the APIs based on one or more various measurements of performance;
receive a subscription request from a subscriber for a particular API of the APIs;
monitor performance of the particular API for a predetermined event that includes a change in at least one of the performance status for the particular API and the one or more various measurements of performance of the particular API;
when the predetermined event occurs, register a time interval of the predetermined event;
compare the predetermined event, the performance status for the particular API, and the time interval for the predetermined event to a table or database of information that includes notification and alert rules for the particular API that specify notification policies for combinations of various predetermined events, various performance statuses, and corresponding length of time intervals; and
when the predetermined event, the performance status of the API, and the time interval match at least one of the notification and alert rules, send a notification or alert to the subscriber based on the notification policy for the at least one of the notification and alert rules.

12. The computer system of claim 11, wherein:
the notification and alert rules are provided by the subscriber; and
existence of the match is published to a notification service, and the notification service sends the notification or alert to the subscriber based on the notification policy for the at least one of the notification and alert rules.

13. The computer system of claim 11, wherein the notification policy comprises sending the notification or alert to a first user at a first delivery address, and the program instructions are further operable to cause the computer system to monitor for acknowledgement of the notification or alert.

14. The computer system of claim 13, wherein when the acknowledgement of the notification or alert is not received within a predetermined amount of time, the program instructions are further operable to cause the computer system to send the notification or alert to a second user at a second delivery address.

15. The computer system of claim 11, wherein the program instructions are further operable to cause the computer system to:
display the performance status for each API; and
receive a subscriber message including an identifier of the subscriber and an indication of the particular API to which the subscriber intends to subscribe.

16. The computer system of claim 15, wherein the displaying comprises generating a graphical user interface comprising a dashboard that includes the performance status for each API shown in proximity to each corresponding API, wherein the performance status for each API is shown as a visual indicator of a quantifiable health metric determined for each API.

17. The computer system of claim 16, wherein:
the assessing comprises determining the quantifiable health metric for each API that is indicative of the performance status for each API; and
the quantifiable health metric is either weighted or non-weighted.

18. The computer system of claim 17, the predetermined event further includes a change in at least one of the performance status for the particular API, the one or more various measurements of performance of the particular API, and the quantifiable health metric.

19. A computer program product comprising computer readable program instructions stored on non-transitory computer readable storage medium, the computer readable program instructions causing a computing device to:
assess a performance status for each application programming interface (API) of a plurality of APIs based on one or more various measurements of performance;
receive a subscription request from a subscriber for a particular API of the APIs;
monitor performance of the particular API for a predetermined event that includes a change in at least one of the performance status for the particular API and the one or more various measurements of performance of the particular API;
when the predetermined event occurs, register a time interval of the predetermined event;
compare the predetermined event, the performance status for the particular API, and the time interval for the predetermined event to a table or database of information that includes notification and alert rules for the particular API that specify notification policies for combinations of various predetermined events, various performance statuses, and corresponding length of time intervals; and
when the predetermined event, the performance status of the API, and the time interval match at least one of the notification and alert rules, send a notification or alert to the subscriber based on the notification policy for the at least one of the notification and alert rules.

20. The computer program product of claim 19, wherein:
the one or more various measurements of performance of the APIs are obtained from stubs on one or more computing devices operably connected to a network;
the notification policy comprises sending the notification or alert to a first user at a first delivery address, and the computer readable program instructions are further operable to cause the computing device to monitor for acknowledgement of the notification or alert; and
when the acknowledgement of the notification or alert is not received within a predetermined amount of time, the computer readable program instructions are further operable to cause the computing device to send the notification or alert to a second user at a second delivery address.
